(19) United States
(12) Patent Application Publication
(10) Pub. No.: US 2026/0106874 A1
(43) Pub. Date: Apr. 16, 2026

(54) CREDENTIAL-LESS ACCESS TO REMOTE RESOURCES

(71) Applicant: Snowflake Inc., Bozeman, MT (US)

(72) Inventors: Samy Boshra-Riad, Bellevue, WA (US); Mohamad Raja Gani Mohamad Abdul, Fremont, CA (US); Bhanu Prakash, Kirkland, WA (US); Niranjan Kumar Sharma, Redmond, WA (US); Nitya Kumar Sharma, Bellevue, WA (US); Prasoon Shukla, Sunnyvale, CA (US)

(21) Appl. No.: 18/916,995

(22) Filed: Oct. 16, 2024

(51) Int. Cl. H04L 9/40

(52) U.S. Cl. CPC H04L 63/104; H04L 63/0263; H04L 63/20

(57) ABSTRACT

Provided herein are systems, methods, and computer-storage media for credential-less access to remote resources. An example method includes creating, by at least one hardware processor, a security integration object. The security integration object includes an identification of a role associated with access to an external resource. The method includes creating a secret object comprising a token associated with the security integration object. The method includes binding the security integration object and the secret object to generate a storage integration object. The storage integration object includes an external access integration. The method includes retrieving a cloud provider token during execution of a user-defined function (UDF). The method includes granting the UDF access to the external resource based on authenticating the cloud provider token using the external access integration.

### TECHNICAL FIELD

Embodiments of the disclosure relate generally to a network-based database system (NBDS) and, more specifically, to techniques for credential-less access to remote resources.

### BACKGROUND

A cloud data warehouse (also referred to as a “network-based database system,” a “network-based data warehouse,” or simply as a “data warehouse”) is a network-based system used for data analysis and reporting that comprises a central repository of integrated data from one or more disparate sources. A cloud data warehouse can store current and historical data that can be used to create analytical reports for an enterprise. To this end, data warehouses typically provide business intelligence tools, tools to extract, transform, and load data into the repository, and tools to manage and retrieve metadata.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based database system with an external access manager (EAM) in communication with a cloud storage platform, in accordance with some embodiments of the present disclosure.

FIG. 2 is a block diagram illustrating the components of a compute service manager using an EAM, in accordance with some embodiments of the present disclosure.

FIG. 3 is a block diagram illustrating components of an execution platform, in accordance with some embodiments of the present disclosure.

FIG. 4 is a data flow diagram illustrating the use of an external credential-less stage object and a storage integration object within an NBDS to load or unload data at a storage location within a cloud storage provider system to the NBDS, in accordance with some embodiments of the present disclosure.

FIG. 5 is a block diagram of a UDF-based external access architecture, in accordance with some embodiments of the present disclosure.

FIG. 6 illustrates an example code for linking a role (e.g., an IAM role) with external access integration, in accordance with some embodiments of the present disclosure.

FIG. 7 illustrates an example code for linking a role (e.g., an IAM role) with network rules, in accordance with some embodiments of the present disclosure.

FIG. 8 illustrates an example code for linking external access integration with application programming interface (API) integration, in accordance with some embodiments of the present disclosure.

FIG. 9 illustrates an example code for linking external access integration with API integration via a user-defined extension (UDx), in accordance with some embodiments of the present disclosure.

FIG. 10 illustrates an example code for security integration to support cloud providers'assumed roles, in accordance with some embodiments of the present disclosure.

FIG. 11 is a block diagram of an NBDS configured to perform credential-less access to external resources, in accordance with some embodiments of the present disclosure.

FIG. 12 illustrates an example code for role-based security integration, in accordance with some embodiments of the present disclosure.

FIG. 13 is a flow diagram illustrating the operations of an NBDS in performing a method for credential-less access to external resources, in accordance with some embodiments of the present disclosure.

FIG. 14 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

In the present disclosure, physical units of data that are stored in a data platform—and that make up the content of, e.g., database tables in customer accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internally in the data platform, a given file is referred to herein as an “internal file” and may be stored in (or at, or on, etc.) what is referred to herein as an “internal storage location.” If stored external to the data platform, a given file is referred to herein as an “external file” and is referred to as being stored in (or at, or on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, eXtensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other examples of unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

As used herein, the term “table” indicates a mutable bag of rows, supporting time travel up to a retention period. As used herein, the term “view” indicates a named SELECT statement, conceptually similar to a table. In some aspects, a view can be secure, which prevents queries from getting information on the underlying data obliquely.

As used herein, the term “external resource” indicates a communication or storage resource that can be reached via a communication link. Examples of external resources include a storage resource (e.g., an external storage resource), an API gateway, a storage service, a Kafka resource, a storage vault, etc.

External stages are components within a cloud data system that facilitate integrations between the cloud data system and a customer-managed storage location (referred to herein as “storage integrations”). In general, external stages are used to load data to and unload data from customer-managed storage locations. In conventional implementations, external stages are provided with secret security credentials to read data from and write data to these storage locations. However, the exchange of the secret security credentials creates vulnerabilities that may lead to exposure of the secret security credentials, which may lead to unauthorized access to data. Additionally, in conventional implementations, cloud data system account administrators have limited ability to prohibit the creation of external stages by members in an organization, and an external stage could potentially be used to exfiltrate confidential data to a personal location. Further, storage owners do not have fine-grained control over access permissions for the storage locations. Conventional external stages are also limited to use in a single file path and are not able to be used in another file path, even if the credentials used to create the external stage are applicable to the other file path.

Existing techniques for accessing storage resources are based on customers managing their secrets for each cloud service provider (CSP) resource, which by default requires handling the lifecycle of secrets either within the NBDS or externally. In some aspects, credential management is based on users being responsible for managing secrets, such as JSON Web Token (JWT) authorization tokens, to access remote resources. This includes handling the lifecycle of these secrets, which can be complex and prone to errors. Additionally, user-defined functions (UDFs)/Stored Procedures (sprocs) connect to remote resources via TCP, requiring user-managed credentials. These approaches can lead to security issues, ongoing maintenance challenges, and continuity concerns for storage access jobs. More specifically, manual maintenance is error-prone and can cause availability issues. Security management of customers'secrets is a security concern as customers need to store their credentials explicitly.

The disclosed role-based access control (RBAC) techniques enable credential-less access to remote resources through external access, allowing users to communicate with any remote endpoint authorized by an assumed role associated with an authentication and identity management system (AIMS) (e.g., the Amazon® AWS Identity and Access Management (IAM)). In some aspects, the NBDS can manage a user object (also referred to as an IAM user or an AIMS user) to assume an IAM role on behalf of customer resources (e.g., storage resources). In some aspects, the NBDS can configure an external access manager (EAM), which can be used to perform the disclosed techniques. For example, the EAM can be configured to perform the proposed RBAC-based techniques, which can include the following configurations:
(a) Credential-less access to CSP resources. The disclosed techniques can be used to enable credential-less access to remote resources through external access, allowing users to communicate with any remote endpoint authorized by an IAM-assumed role.
(b) RBAC implementation. The disclosed techniques can be used to introduce RBAC to enforce specific access permissions, preventing any single user from having overarching control (e.g., avoiding superuser scenarios). Additionally, multiple IAM users can be created for each service account (e.g., Amazon® AWS account), replacing the current single-user approach.
(c) Multi-User Approach. The NBDS can randomly select one of the multiple CSP users created for an account at the integration level. This ensures no single user has complete control, distributing responsibilities and minimizing security risks. This approach allows for more secure and flexible management of resource access.
(d) Decentralized credential management. In some aspects, the NBDS manages multiple dedicated IAM users for each CSP account, distributing the responsibility for handling access tokens. This approach reduces the risk associated with over-permission access and single points of failure.
(e) Enhanced security integration. A security integration object (e.g., an AWS-IAM type security integration object) can be generated and linked to the IAM users and their corresponding roles. The EAM can randomly choose one of these IAM users to manage access tokens for each resource. This approach enhances security by decentralizing access control and adhering to RBAC best practices.

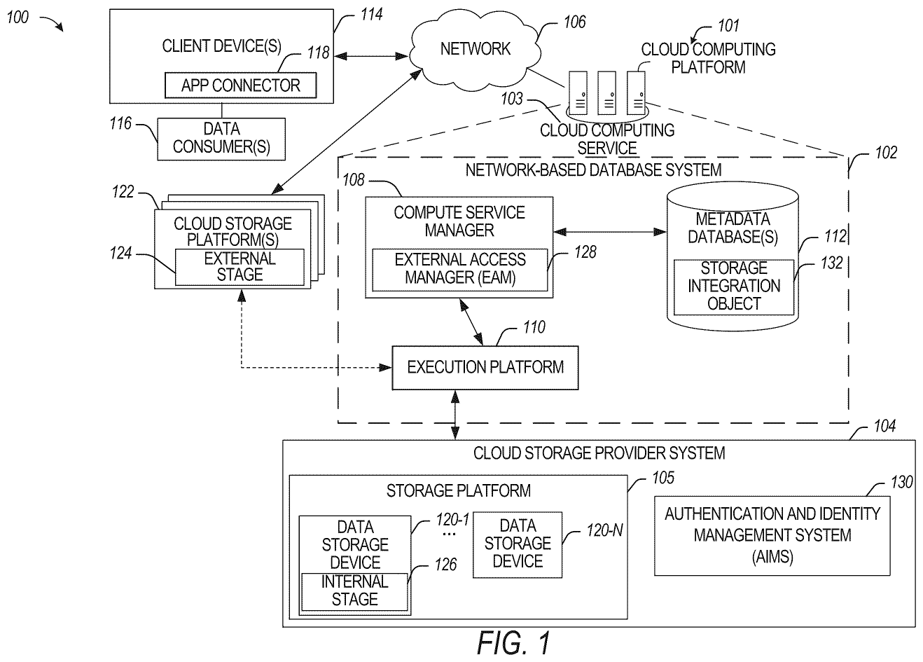

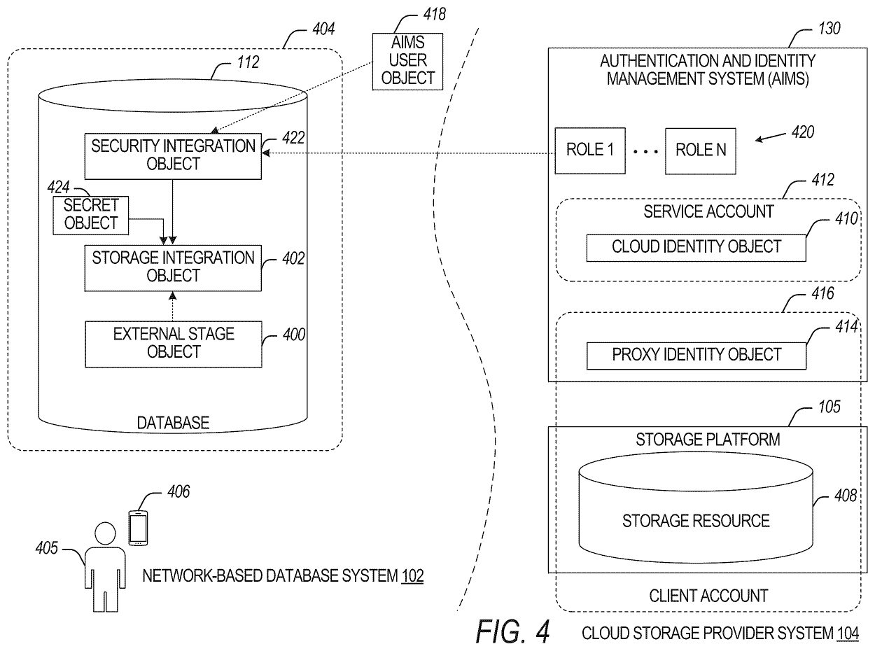

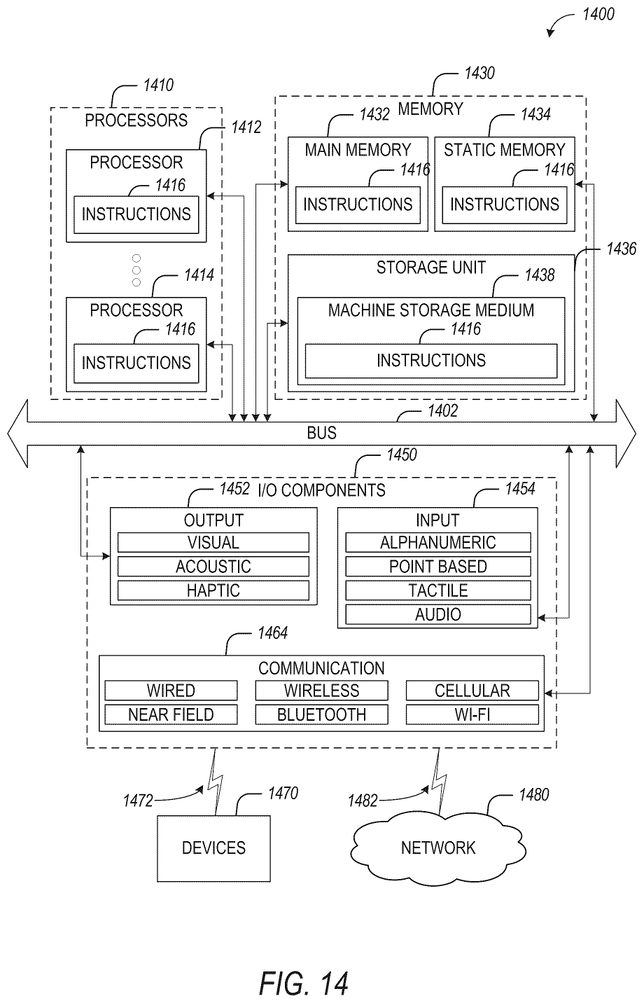

The various embodiments that are described herein are described with reference, where appropriate, to one or more of the various figures. An example computing environment using an EAM to perform RBAC-related functionalities, including credential-less access to external resources, is discussed in connection with FIGS. 1-3. Example EAM configurations associated with the RBAC-related functionalities are discussed in connection with FIGS. 4-13. A more detailed discussion of example computing devices that may be used in connection with the disclosed techniques is provided in connection with FIG. 14.

FIG. 1 illustrates an example computing environment 100 that includes a network-based database system 102 (or NBDS 102) with an external access manager (EAM) in communication with a cloud storage platform, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not explicitly described herein. In other embodiments, the computing environment may comprise another type of network-based database system or a cloud data platform. For example, in some aspects, the computing environment 100 may include a cloud computing platform 101 with the network-based database system 102, cloud storage provider system 104 with storage platform 105, and cloud storage platforms 122. The cloud computing platform 101 provides computing resources and storage resources that may be acquired (purchased) or leased (e.g., by data providers and data consumers) and configured to execute applications and store data.

The cloud computing platform 101 may host a cloud computing service 103 that facilitates storage of data on the cloud computing platform 101 (e.g., data management and access) and analysis functions (e.g., SQL queries, analysis), as well as other processing capabilities (e.g., performing the skew mitigation functions described herein). The cloud computing platform 101 may include a three-tier architecture: data storage (e.g., storage platforms 105 and 122), an execution platform 110, and a compute service manager 108 providing cloud services. In some embodiments, the execution platform 110 is configured to provide RBAC-related functionalities, including credential-less access to external resources, using an external access manager (EAM) 128.

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The customer's servers and cloud-storage platforms are both examples of what a given customer could use as what is referred to herein as an external storage location. The cloud computing platform 101 could also use a cloud-storage platform, which is referred to herein as an internal storage location concerning the data platform.

From the perspective of the network-based database system 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and where external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based database system 102 of the cloud computing platform 101 is in communication with the cloud storage provider system 104 and cloud storage platforms 122 (e.g., AWS®, Microsoft Azure Blob Storage®, or Google Cloud Storage), client device 114 (e.g., a data provider), and data consumer 116 via network 106. The network-based database system 102 is a network-based system used for reporting and analysis of integrated data from one or more disparate sources, including one or more storage locations within the storage platform 105 of the cloud storage provider system 104. The cloud storage provider system 104 comprises an authentication and identity management system 130 (also referred to as AIMS 130), providing on-demand computer system resources such as data storage via the storage platform 105 and computing power to the network-based database system 102. In some aspects, AIMS 130 includes Amazon® AWS IAM functionalities.

The network-based database system 102 comprises a compute service manager 108, an execution platform 110, and one or more metadata databases 112. The network-based database system 102 hosts and provides data reporting and analysis services (as well as additional services such as the disclosed skew mitigation functions) to multiple client accounts, including an account of the data provider associated with client device 114 and an account of the data consumer 116.

In some embodiments, the compute service manager 108 comprises the EAM 128, which can be used to provide RBAC-related functionalities, including credential-less access to external resources, using one or more integration objects (e.g., storage integration object 132 stored in the one or more metadata databases 112) as well as functionalities associated with AIMS 130 in the cloud storage provider system 104. A more detailed description of the functions provided by the EAM 128 is provided in connection with, e.g., FIGS. 4-13.

The compute service manager 108 coordinates and manages operations of the network-based database system 102. The compute service manager 108 also performs query optimization and compilation and manages clusters of computing services that provide compute resources (also referred to as “virtual warehouses”). The compute service manager 108 can support any number of client accounts, such as end-users providing data storage and retrieval requests, accounts of data providers, accounts of data consumers, system administrators managing the systems and methods described herein, and other components/devices that interact with the compute service manager 108.

The compute service manager 108 is also in communication with a client device 114. The client device 114 corresponds to a user of one of the multiple client accounts (e.g., a data provider) supported by the network-based database system 102. The data provider may utilize application connector 118 at the client device 114 to submit data storage, retrieval, and analysis requests to the compute service manager 108 as well as to access or configure other services provided by the compute service manager 108 (e.g., services associated with the disclosed RBAC-related functions).

Client device 114 (also referred to as user device 114) may include one or more of a laptop computer, a desktop computer, a mobile phone (e.g., a smartphone), a tablet computer, a cloud-hosted computer, cloud-hosted serverless processes, or other computing processes or devices may be used to access services provided by the cloud computing platform 101 (e.g., cloud computing service 103) by way of a network 106, such as the Internet or a private network.

In the description below, actions are ascribed to users, particularly consumers and providers. Such actions shall be understood to be performed concerning client device (or devices) 114 operated by such users. For example, a notification to a user may be understood to be a notification transmitted to the client device 114, input or instruction from a user may be understood to be received by way of the client device 114, and interaction with an interface by a user shall be understood to be interaction with the interface on the client device 114. In addition, database operations (joining, aggregating, analysis, etc.) ascribed to a user (consumer or provider) shall be understood to include performing such actions by the cloud computing service 103 in response to an instruction from that user.

In some aspects, a data consumer 116 can communicate with the client device 114 to access functions offered by the data provider. Additionally, the data consumer can access functions (e.g., skew-related functions) offered by the network-based database system 102 via network 106.

The compute service manager 108 is also coupled to one or more metadata databases 112 that store metadata about various functions and aspects associated with the network-based database system 102 and its users. For example, a metadata database 112 may include a summary of data stored in remote data storage systems as well as data available from a local cache. Additionally, a metadata database 112 may include information regarding how data is organized in remote data storage systems (e.g., the cloud storage platforms 122 and the storage platform 105) and the local caches. Information stored by a metadata database 112 allows systems and services to determine whether a piece of data needs to be accessed without loading or accessing the actual data from a storage device.

The compute service manager 108 is further coupled to the execution platform 110, which provides multiple computing resources (e.g., execution nodes) that execute, for example, various data storage, data retrieval, and data processing tasks. The execution platform 110 is coupled to the cloud storage provider system 104 and cloud storage platforms 122. The storage platform 105 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data storage technology. Additionally, the storage platform 105 may include distributed file systems (such as Hadoop Distributed File Systems (HDFS)), object storage systems, and the like. In some embodiments, at least one internal stage 126 may reside on one or more of the data storage devices 120-1 - 120-N, and at least one external stage 124 may reside on one or more of the cloud storage platforms 122.

In some embodiments, communication links between elements of the computing environment 100 are implemented via one or more data communication networks, such as network 106. The one or more data communication networks may utilize any communication protocol and any type of communication medium. In some embodiments, the data communication networks are a combination of two or more data communication networks (or sub-networks) coupled with one another. In alternate embodiments, these communication links are implemented using any communication medium and any communication protocol.

The compute service manager 108, metadata database 112, execution platform 110, and cloud storage provider system 104 are shown in FIG. 1 as individual discrete components. However, each of the compute service manager 108, metadata database 112, execution platform 110, cloud storage provider system 104, and cloud storage platforms 122 may be implemented as a distributed system (e.g., distributed across multiple systems/platforms at multiple geographic locations). Additionally, each of the compute service manager 108, metadata database(s) 112, execution platform 110, cloud storage provider system 104, and cloud storage platforms 122 can be scaled up or down (independently of one another) depending on changes to the requests received and the changing needs of the network-based database system 102. Thus, in the described embodiments, the network-based database system 102 is dynamic and supports regular changes to meet the current data processing needs.

During typical operations, the network-based database system 102 processes multiple jobs as determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the storage platform 105. It is desirable to retrieve as much data as possible from caches within the execution platform 110 because the retrieval speed is typically much faster than retrieving data from the storage platform 105.

As shown in FIG. 1, the cloud computing platform 101 of the computing environment 100 separates the execution platform 110 from the cloud storage provider system 104. In this arrangement, the processing resources and cache resources in the execution platform 110 operate independently of the data storage devices 120-1 to 120-N in the storage platform 105 of the cloud storage provider system 104. Thus, the computing resources and cache resources are not restricted to specific data storage devices 120-1 to 120-N. Instead, all computing resources and all cache resources may retrieve data from and store data to any of the data storage resources in the storage platform 105.

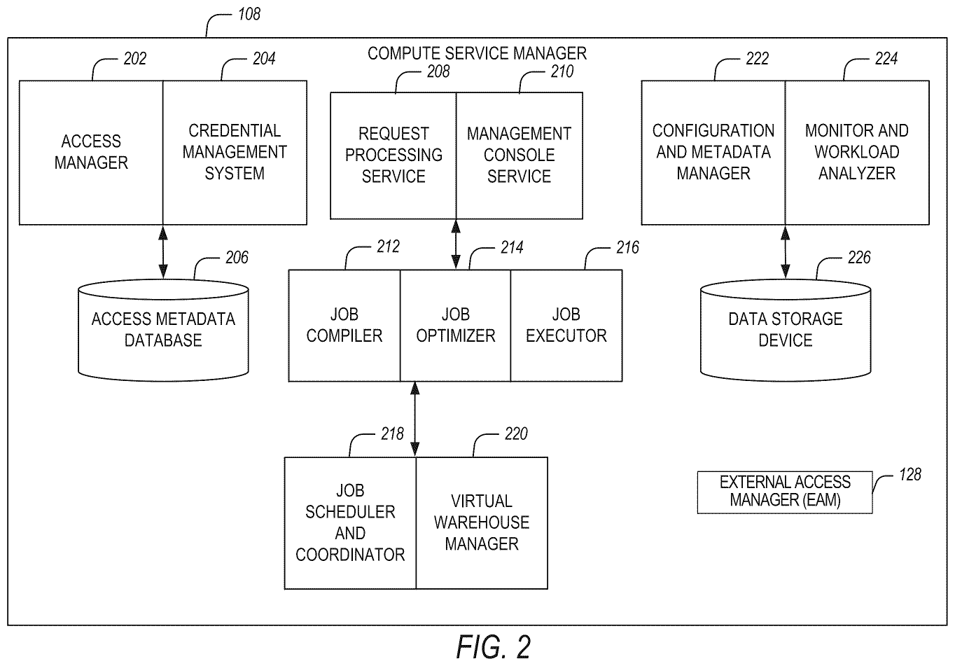

FIG. 2 is a block diagram illustrating the components of the compute service manager 108 using a skew manager, in accordance with some embodiments of the present disclosure. As shown in FIG. 2, the compute service manager 108 includes an access manager 202 and a credential management system 204 coupled to an access metadata database 206, which is an example of the metadata database(s) 112. Access manager 202 handles authentication and authorization tasks for the systems described herein. The credential management system 204 facilitates the use of remotely stored credentials to access external resources, such as data resources in a remote storage device. As used herein, the remote storage devices may also be referred to as “persistent storage devices” or “shared storage devices.” For example, the credential management system 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in storage platform 105.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. Job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an embodiment, the job scheduler and coordinator 218 determines a priority for internal jobs that are scheduled by the compute service manager 108 with other “outside” jobs, such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries.

Additionally, the compute service manager 108 includes a configuration and metadata manager 222, which manages the information related to the data stored in the remote data storage devices and the local buffers (e.g., the buffers in the execution platform 110). The configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based database system 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the network-based database system 102. For example, data storage device 226 may represent buffers in execution platform 110, storage devices in storage platform 105, or any other storage device.

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing query A should not be allowed to request access to data source D (e.g., data storage device 226) that is not relevant to query A. Similarly, a given execution node (e.g., execution node 302-1) may need to communicate with another execution node (e.g., execution node 302-2) and can be disallowed from communicating with a third execution node (e.g., execution node 312-1). In some aspects, any such illicit communication can be recorded (e.g., in a log or other location). Also, the information stored on a given execution node is restricted to data relevant to the current query, and any other data is unusable, rendered so by destruction or encryption where the key is unavailable.

In some embodiments, the compute service manager 108 comprises the EAM 128, which can be used to provide RBAC-related functionalities, including credential-less access to external resources, using one or more integration objects (e.g., storage integration object 132 stored in the one or more metadata databases 112) as well as functionalities associated with AIMS 130 in the cloud storage provider system 104.

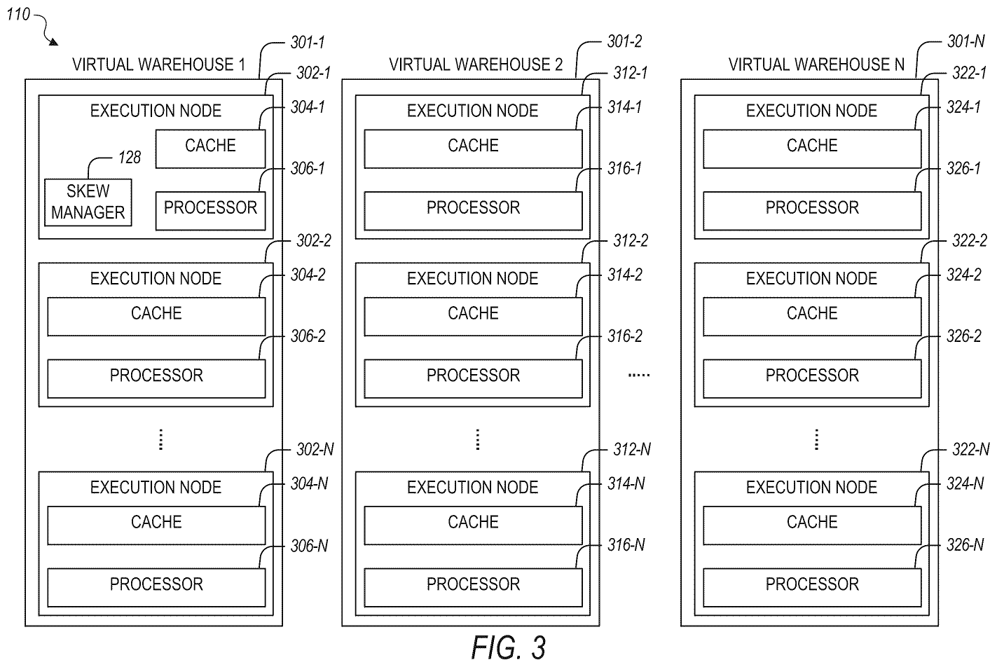

FIG. 3 is a block diagram illustrating components of the execution platform 110, in accordance with some embodiments of the present disclosure. As shown in FIG. 3, the execution platform 110 includes multiple virtual warehouses, including virtual warehouse 1 (or 301-1), virtual warehouse 2 (or 301-2), and virtual warehouse N (or 301-N). Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the storage platform 105).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, they can access data from any of the data storage devices 120-1 to 120-N within the storage platform 105. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes: 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes: 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes: 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternative embodiments may include execution nodes containing any number of processors and any number of caches. Additionally, the caches may vary in size among the different execution nodes. The caches shown in FIG. 3 store, in the local execution node, data that was retrieved from one or more data storage devices in the storage platform 105. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the storage platform 105.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, which is useful for tasks that require fast scanning of large amounts of data. In some embodiments, the cache resources and computing resources associated with a particular execution node are determined when the execution node is created based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, virtual warehouses 1, . . . , and N may be implemented using multiple computing systems at multiple geographic locations. For example, virtual warehouse 1 can be implemented by a computing system at a first geographic location, while virtual warehouses 2 and n are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault-tolerant. For example, if one virtual warehouse fails, that virtual warehouse is quickly replaced with a different virtual warehouse at a different geographic location.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in the storage platform 105, but each virtual warehouse has its execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

FIG. 4 is a data flow diagram illustrating the use of an external credential-less stage object and a storage integration object within NBDS 102 to load or unload data at a storage location within the cloud storage provider system 104 to the NBDS 102, in accordance with some embodiments of the present disclosure. The external stage object 400 and the storage integration object 402 are examples of the storage integration object 132 illustrated in FIG. 1. The external stage object 400 is generated by the compute service manager 108 (e.g., by the EAM 128) and stored in the database 112. The external stage object 400 is generated by the compute service manager 108 within a client account 404. The compute service manager 108 creates the external stage object 400 based on input received from a computing device in communication with the NBDS 102. For example, a user 405 of the client account 404 can utilize a command line or other user interface provided to a computing device 406 by the NBDS 102 to provide a command to create the external stage object 400.

The external stage object 400 is a component used to load or unload data at a storage location within the storage platform 105 to the NBDS 102. In this particular example, the external stage object 400 specifies a storage location corresponding to a storage resource 408 within the storage platform 105 as a location from which data can be loaded or unloaded. The storage resource 408 resides on one or more of the data storage devices 120-1 to 120-N of the storage platform 105. The external stage object 400 further includes a reference (e.g., a pointer) to a storage integration object 402.

The storage integration object 402 is created within the client account 404 by the compute service manager 108 (e.g., the EAM 128) and is stored within the database 112. The compute service manager 108 (e.g., the EAM 128) creates the external stage object 400 based on input received from the computing device 406 of the user 405 of the client account 404 in communication with the NBDS 102. For example, user 405 can utilize the command line or other user interface provided to the computing device 406 by the NBDS 102 to provide a command to create the storage integration object 402.

It should be noted that the user who provides the command to create the external stage object 400 may be a different user from the user who provides the command to create the storage integration object 402. For example, a first user with administrator privileges—an administrative user—may provide the command to create the storage integration object 402 and, as part of the command, may grant permission to a second user to use the storage integration object 402 to create external stage objects. In this example, the second user may provide the command to create the external stage object 400.

The storage integration object 402 defines a storage integration between the NBDS 102 and an externally managed storage location in the storage platform 105. More specifically, the storage integration object 402 describes the properties of a storage integration between the NBDS 102 and the customer-managed storage resource 408 (e.g., a folder, data bucket, or other storage resource). The storage integration object 402 comprises an identifier of a storage location corresponding to the storage resource 408 (e.g., a URL) and an identifier of the cloud storage provider system 104. In some embodiments, the storage integration object 402 may further specify one or more storage locations to which access to data is to be denied. For example, the external stage object 400 may identify a base storage location to which access is to be allowed using a file path, and the storage integration object 402 may further identify a portion of the base storage location to which access is to be allowed or denied with a sub-path of the file path.

Once created, the compute service manager 108 associates the storage integration object 402 with a cloud identity object 410 within a service account 412 maintained by the authentication and identity management system 130 that is associated with the NBDS 102 and the client account 404. The cloud identity object 410 is an identity within the cloud storage provider system 104 associated with the client account 404. The cloud identity object 410 may be created when the client account 404 is created. A unique identifier (e.g., an Amazon Resource Name (ARN)) is associated with the cloud identity object 410 at creation. A storage provider administrator can utilize the authentication and identity management system 130 to grant permission to the cloud identity object 410 to access storage using the identifier of the cloud identity object 410.

The compute service manager 108 may store cloud storage provider identity identifiers in the database 112 in an encrypted format. The compute service manager 108 may further store security credentials associated with each cloud storage provider identity in the database 112 in an encrypted format.

The cloud storage provider system 104 generates a proxy identity object 414 within a client account 416 of the cloud storage provider system 104. The client account 416 is the account of the client corresponding to the client account 404 within the cloud storage provider system 104. The cloud storage provider system 104 generates the proxy identity object 414 based on input specified by an administrative user of the client account 416. In some instances, the administrative user of the client account 416 is the user 405.

The proxy identity object 414 defines a proxy identity with an associated trust policy for making service requests within the cloud storage provider system 104. More specifically, the proxy identity object 414 includes a set of permissions that allow the cloud identity object 410 to assume the proxy identity to read data from and write data to the storage resource 408. Rather than being uniquely associated with a single person like a user, the proxy identity object 414 defines a proxy identity that can be assumed by multiple users.

In some instances, the proxy identity defined by the proxy identity object 414 does not have long-term security credentials, and in these instances, another identity that assumes the proxy identity utilizes temporary security credentials provided by the authentication and identity management system 130 to access the proxy identity. Consistent with these embodiments, the temporary security credentials may expire after an expiration time.

The cloud storage provider system 104 assigns a unique identifier to the proxy identity object 414 (e.g., an Amazon® Resource Name (ARN)). The storage administrator uses the unique identifier of the proxy identity object 414 to grant access to storage.

In response to receiving a command to load data from the storage location corresponding to the storage resource 408 to an internally managed storage resource (e.g., a table) or to unload data from the internally managed storage resource to the storage location corresponding to the storage resource 408, the NBDS 102 uses the external stage object 400 to load or unload the data. In particular, the compute service manager 108 identifies and accesses the storage integration object 402 using the external stage object 400 and uses the storage integration object 402 to access security credentials associated with the cloud identity object 410. The compute service manager 108 uses security credentials associated with the cloud identity object 410 to access security credentials from the authentication and identity management system 130 to allow the cloud identity object 410 to assume the proxy identity defined by the proxy identity object 414 to load or unload data between the internal storage resource and the storage resource 408.

In some aspects, AIMS 130 can be based on a web service, such as Amazon® AWS Identity and Access Management (IAM), configured to securely manage access to external resources (e.g., AWS resources). In some aspects, AIMS 130 enables centralized permission management, empowering users to define which external resources (e.g., storage or compute resources) can be accessed. Additionally, AIMS 130 facilitates seamless control over authentication (sign-in) and authorization (permissions) for resource usage.

In some aspects, AIMS 130 includes roles 420 (e.g., roles 1, . . . , N). In some aspects, roles 420 can comprise AWS roles. In some aspects, roles 420 are entities equipped with permissions policies that dictate actions allowed on AIMS resources when assumed by a user (e.g., IAM user).

When a user (e.g., an IAM user) assumes a role, the user temporarily inherits the permissions assigned to that role. This process is known as assuming the role.

In some aspects, policies associated with a role determine the actions the assumed user can perform, and on which AIMS resources the user can take those actions. These policies can be identity-based or resource-based. Identity-based policies are attached to IAM identities (e.g., users, groups, or roles) and dictate permissions based on the entity attempting to access AIMS resources. They are evaluated based on the permissions granted to the identity.

Resource-based policies are directly attached to AIMS resources (such as S3 buckets, Lambda functions, SQS queues, etc.) and control access to the resource by other accounts or services. In some aspects, these policies define permissions based on the entity attempting to access the resource and are evaluated accordingly.

In some aspects, EAM 128 can create the security integration object 422. The security integration object 422 can include an identification of a role (e.g., one of the roles 420) associated with access to external storage (e.g., storage resource 408 of the storage platform 105).

In some aspects, EAM 128 creates secret object 424, which can include a token. The token can be associated with the security integration object 422.

In some aspects, EAM 128 binds the security integration object 422 and the secret object 424 to generate the storage integration object 402.

In some aspects, EAM 128 retrieves a cloud provider token during the execution of a user-defined function (UDF).

In some aspects, EAM 128 grants the UDF access to the external storage based on authenticating the cloud provider token using the storage integration object 402.

In some aspects, EAM 128 causes authorization of a user object (e.g., AIMS user object 418) of the NBDS 102 to access the role (e.g., based on a request to user 405 to grant the AIMS user object 418 access to one or more of roles 420). In some aspects, EAM 128 grants the AIMS user object 418 access to the external storage based on the authenticating of the cloud provider token using the storage integration object.

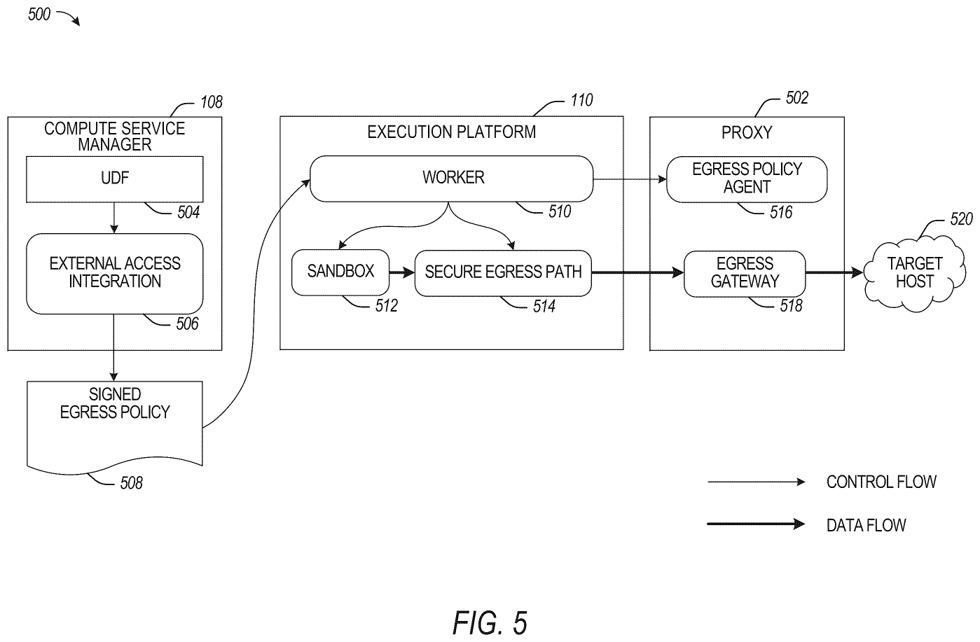

FIG. 5 is a block diagram of a UDF-based external access architecture 500, in accordance with some embodiments of the present disclosure. Referring to FIG. 5, the UDF-based external access architecture 500 is configured with the compute service manager 108, the execution platform 110, and a proxy object 502.

The compute service manager 108 can include a UDF 504, causing the generation of an external access integration 506. The external access integration 506 can include the storage integration object 402 based on security integration object 422 and the secret object 424.

In some aspects, UDF 504 is authorized to access external resources at target host 520 via the external access integration 506. In some aspects, EAM 128 of the compute service manager 108 can generate and sign the egress policy 508 for UDF 504 and deliver the policy to the worker node 510 at the execution platform 110 with the query SDL execution plan. In some aspects, the egress policy 508 contains the list of allowed external resources (e.g., IP addresses).

In some aspects, worker node 510 will perform the following two functions before the UDF 504 starts: send the policy to the egress proxy (e.g., proxy object 502, which can include proxy identity object 414) and set up a secure egress path 514 for the sandbox process 512 where the UDF 504 can execute.

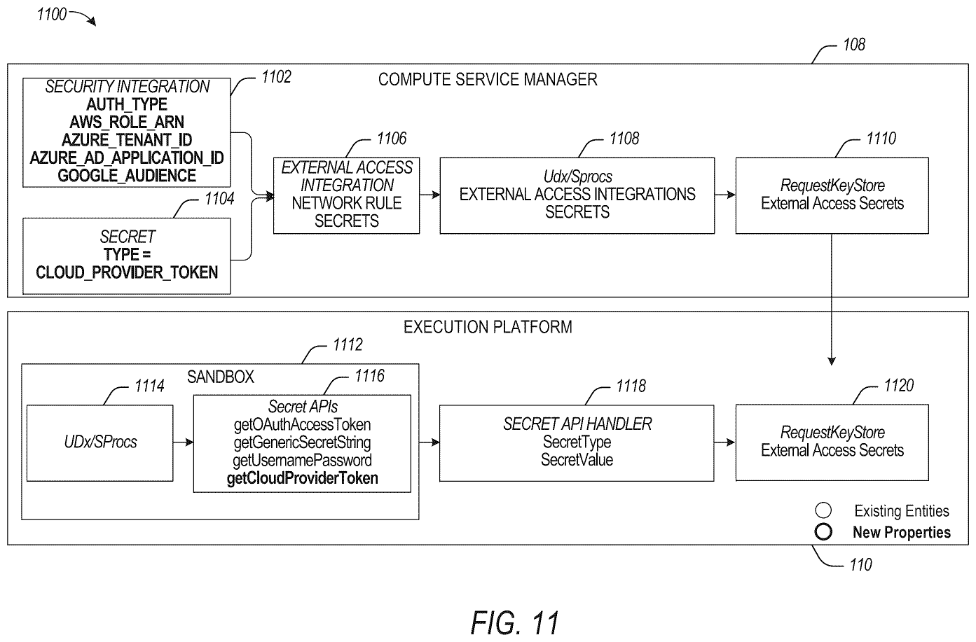

Once the UDF starts to run, the egress traffic from the UDF will be strictly forwarded through the secure egress path 514 to the egress proxy and eventually be allowed to pass through the egress gateway 518 and to the target host 520. Egress traffic can be supervised by the egress policy agent 516 based on the egress policy 508. In some aspects, a secret input is provided (e.g., via a secret API as illustrated in FIG. 11), and the storage integration object 402 (which can be the same as the external access integration 506) is retrieved based on the provided secret input (e.g., input corresponding to the secret object 424). Authenticating access to the target host 520 is performed based on the external access integration 506.

In some aspects, the disclosed techniques enable credential-less access to remote resources through external access, allowing users to communicate with any remote endpoint authorized by an IAM-assumed role.

In some aspects, external access enables UDFs/stored procedures to establish network connections, allowing them to connect to remote resources via TCP. Remote resources can be protected and can require tokens (e.g., JWT authorization tokens) for communication. In some aspects, the EAM can enable customers of the NBDS 102 to create secrets and link them with external access integration for use in linked UDFs/stored procedures, offering an effective solution to avoid managing secrets in user code. However, customers may still need to manage secrets and bear responsibility for overseeing their lifecycle.

In some aspects, external functions facilitate credential-less access to API gateways and storage integration, enabling connections to storage buckets without the need for credentials. In some aspects, external function or storage integration delegates authentication responsibilities to an NBDS identity and access management (IAM) entity (e.g., AIMS user object 418).

The disclosed techniques are aligned with the concept of credential-less access to remote endpoints and can be based on the notion of the NBDS managing secrets for external access. In some aspects, the NBDS 102 creates (e.g., via the EAM 128) a dedicated IAM user (e.g., AIMS user object 418) for each AIMS account (e.g., AWS account) (with a similar concept for Microsoft® Azure and Google® Cloud Platform, or GCP).

In some aspects, external functions and storage integration utilize the account-specific user object (e.g., IAM user, also referred to as AIMS user object 418) to manage access tokens on behalf of the account. To achieve the same, the disclosed external access integration object (e.g., storage integration object 402) can be configured to store an AWS Identity and IAM user (e.g., the same IAM user used in storage integration, external function, etc.), and an administrator in the customer's organization grants permissions to the integration NBDS IAM user (e.g., the AIMS user object 418) in the AWS account. This enables the NBDS user to assume roles and acquire access tokens for resources based on the attached policies to the role.

To support the assumed role of external access integration, EAM 128 can configure a new property that can be CSP-specific (e.g., the configuration of the security integration object 422 and the secret object 424). A distinction between external function integration or storage integration and external access integration lies in their ability to access multiple resources. While a JWT token can technically grant access to various resources, it may not be the ideal solution for customers requiring limited resource access.

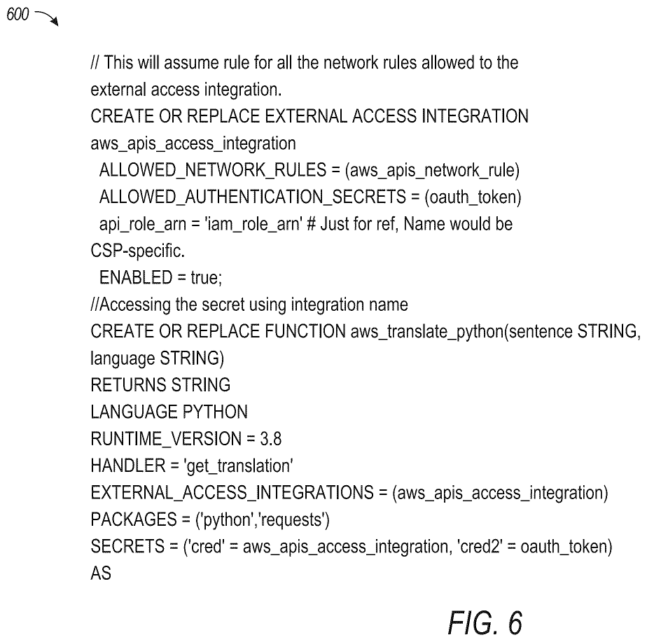

FIG. 6 illustrates an example code 600 for linking a role (e.g., an IAM role) with external access integration, in accordance with some embodiments of the present disclosure. In some aspects, code 600 can be used by EAM 128 to link the IAM role with external access integration, assuming the IAM role at the integration level. In some aspects, access tokens can then be obtained by referencing the integration name, similar to handling secrets. This functionality is associated with no additional layer of dependency or complexity, like security integration. Similar to API integration, external access integration involves links to ARNs.

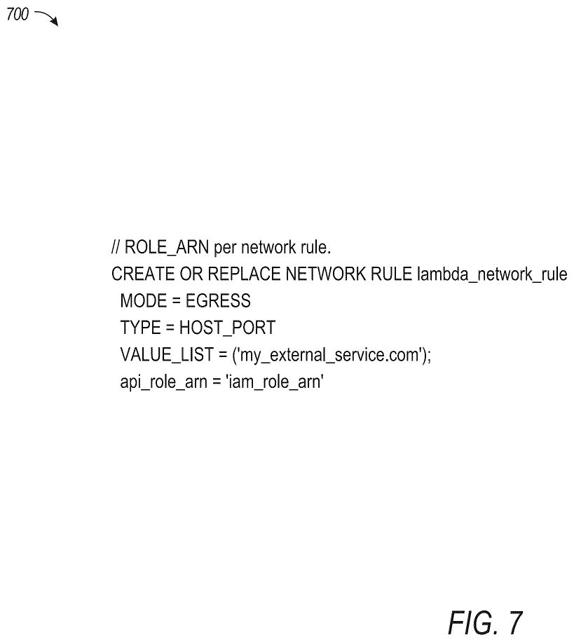

FIG. 7 illustrates an example code 700 for linking a role (e.g., an IAM role) with network rules, in accordance with some embodiments of the present disclosure. In some aspects, code 700 can be used by EAM 128 to link the IAM role with network rules, indicating that assuming the role is applicable to all linked network resources at the network rule level. In some aspects, access tokens can then be obtained by referencing the network rule name, similar to handling secrets. In this regard, resources can be grouped based on roles.

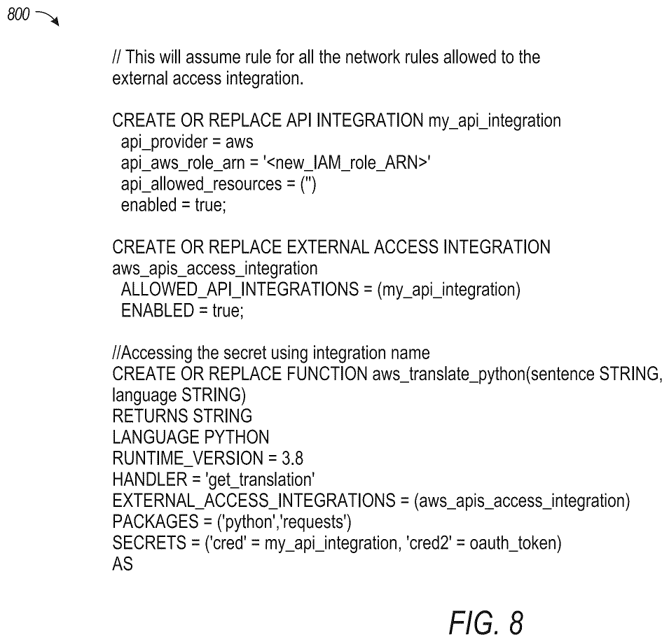

FIG. 8 illustrates an example code 800 for linking external access integration with application programming interface (API) integration, in accordance with some embodiments of the present disclosure. In some aspects, code 800 can be used by EAM 128 to configure using the same API integration as in external functions. The goal is to link external access integration with API integration so that the IAM role is assumed at the API integration level and access tokens can be obtained through permitted API integration names, similar to secrets. In some aspects, API integration includes IAM user binding, so using the same API integration will be automatically covered.

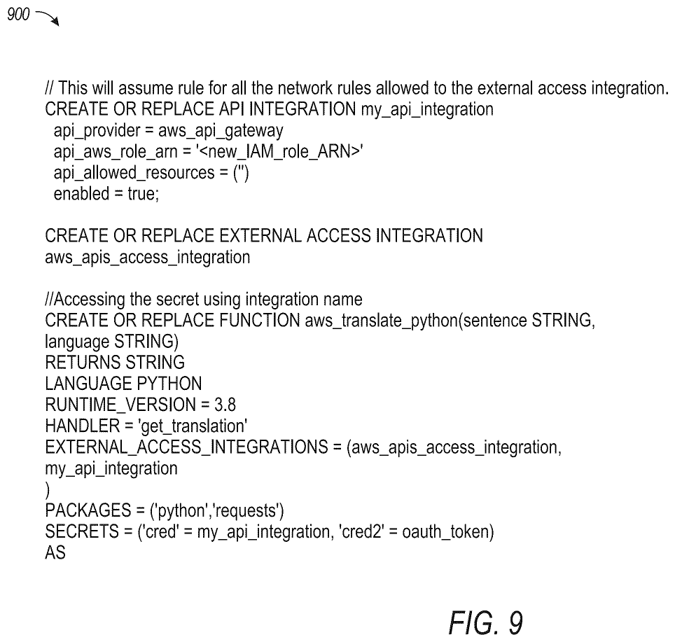

FIG. 9 illustrates an example code 900 for linking external access integration with API integration via a user-defined extension (UDx), in accordance with some embodiments of the present disclosure. In some aspects, code 900 can be used by EAM 128 to configure the use of the same API integration as in external functions. The change lies in linking the API integration with external access, directly connecting it with a user-defined extension (UDx). A UDx internally allows binding with API, alongside external access integration. Access tokens can then be obtained through permitted API integration names, much like secrets. API integration already includes IAM user binding, so most of the above aspects associated with code 900 will be automatically covered.

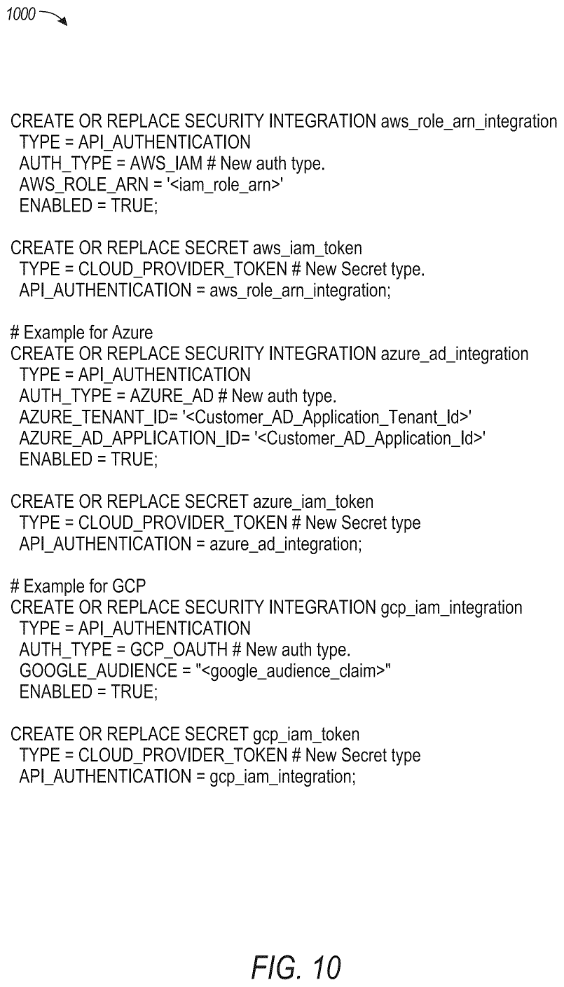

FIG. 10 illustrates an example code 1000 for security integration to support cloud providers' assumed roles, in accordance with some embodiments of the present disclosure.

In some aspects, EAM 128 can be configured to use new authentication types for security integration to support cloud providers' assumed IAM roles. Additionally, a new secret type can be established based on security integration. With this new secret type, the external access flow can remain unchanged after obtaining the secret. This ensures that there are no new terms or learning curves for customers already familiar with security integration and secrets, such as OAuth. Additionally, this functionality maintains the connection between security integration, secrets, and their use in the external access integration.

In some aspects, the disclosed techniques can be configured without extra layers of dependency or complexity but as a method for creating OAuth-type secrets.

Avoiding extra definitions on the NBDS side ensures that customers have a single source of truth in AWS and may not need to duplicate policies on the NBDS side. The EAM 128 can bind the appropriate IAM policy. However, the drawback of this approach is that customers might have to create multiple roles according to their requirements, as at runtime, access tokens are not narrowed down, and they may be privileged based on the IAM policy attached to the IAM role.

FIG. 11 is a block diagram 1100 of an NBDS configured to perform credential-less access to external resources, in accordance with some embodiments of the present disclosure. Referring to FIG. 11, EAM 128 can configure a security integration object 1102 and a secret object 1104 within the compute service manager 108. The security integration object 1102 can be similar to the security integration object 422 and can include an authentication type (e.g., role identification, such as AWS role ARN, Azure tenant ID, Azure application ID, or a Google audience). Secret object 1104 can be similar to secret object 424 and can include a token of the type cloud provider token.

The EAM 128 can generate external access integration 1106, which can be similar to the storage integration object 402 (e.g., binding network rules and secrets such as security integration object 1102 and secret object 1104).

At operation 1108, UDx or stored procedures (Sprocs) are executed to obtain the external access integration and secrets. At operation 1110, the external access secrets (e.g., the external access integration 1106) can be stored in a secure key store.

At the execution platform 110, UDx/Sprocs 1114 can be executed within a sandbox environment 1112 (e.g., a sandbox process). The sandbox environment 1112 can also execute one or more secret APIs 1116 to obtain OAuth access tokens, a generic secret string, a username-password entry, or a cloud provider token (e.g., the type used by the secret object 1104). The execution platform 110 also uses a secret API handler 1118 to retrieve the secret type and value entered via the secret API. An external access integration is then retrieved at operation 1120 based on the secret type and value. The EAM 128 then uses the external access integration to configure credential-less access to an external resource.

In some aspects, the disclosed techniques in FIG. 11 are based on assuming a role/acquiring an access token (e.g., JWT). In some aspects, EAM 128 acquires access tokens (e.g., via the one or more secret APIs 1116) based on default policies applied to IAM roles. Therefore, if an access token requires restricted access, customers can configure appropriate resource policies for the role. In some aspects, customers can associate various integrations/secrets by utilizing different IAM roles, allowing them to customize access within UDx to meet their specific needs. This approach ensures that AWS is the authoritative source, reducing the need for redundant policy definitions within the NBDS.

In some aspects, the one or more secret APIs 1116 can include:
(a) getOAuthAccessToken. This API can be used for retrieving OAuth tokens.
(b) getGenericSecretString. This API can be utilized for obtaining generic string secrets.
(c) getUsernamePassword. This API can be used for retrieving username and password combinations.

Additionally, the EAM 128 can be configured to use the following API for the CLOUD_PROVIDER_TOKEN secret type:
(d) getCloudProviderToken. This API is proposed for obtaining tokens specific to the disclosed CLOUD_PROVIDER_TOKEN type secret, enabling secure access to cloud provider services (e.g., via the secret object 1104).

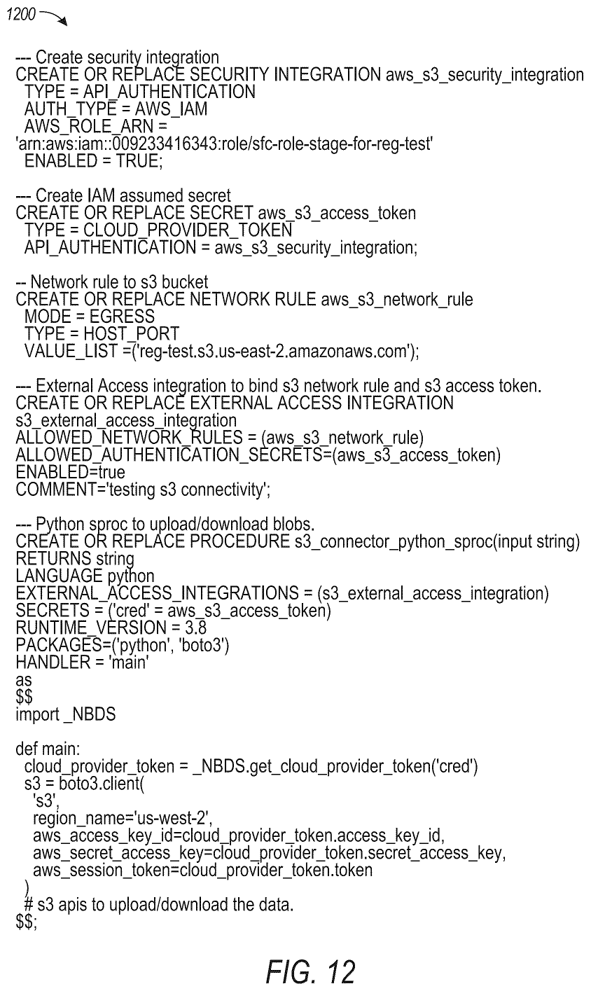

FIG. 12 illustrates example code 1200 for role-based security integration, in accordance with some embodiments of the present disclosure.

In some aspects, code 1200 can be used to configure credential-less access for CSP-specific resources and conditions when the resources align with the NBDS deployment on the same CSP. If there is a misalignment, creating the integration object will result in an error when attempting to use the new property for credential-less access or at runtime if network rules are altered after creating the external access integration. For example, an AWS NBDS deployment can provide credential-less access to AWS resources, while deployments on Azure or GCP can offer similar functionality for their respective resources.

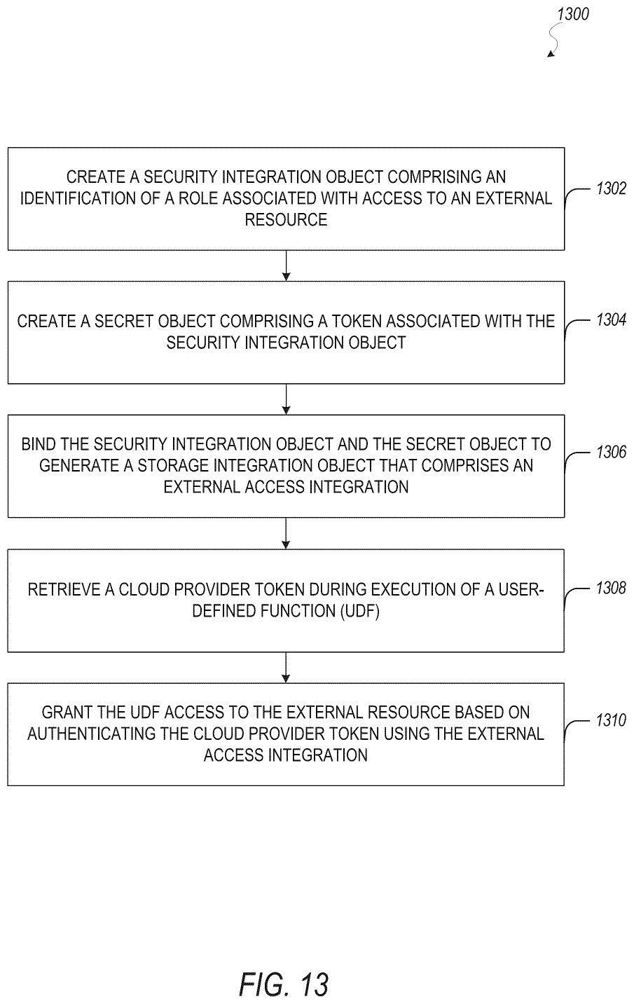

FIG. 13 is a flow diagram illustrating the operations of an NBDS in performing a method for credential-less access to external resources, in accordance with some embodiments of the present disclosure. Method 1300 may be embodied in computer-readable instructions for execution by one or more hardware components (e.g., one or more processors) such that the operations of method 1300 may be performed by components of network-based database system 102, such as components of the compute service manager 108 (e.g., the EAM 128) and/or the execution platform 110 (which components may be implemented as machine 1400 of FIG. 14). Accordingly, method 1300 is described below, by way of example with reference thereto. However, it should be noted that method 1300 may be deployed on various other hardware configurations and is not intended to be limited to deployment within the network-based database system 102.

At operation 1302, EAM 128 can create the security integration object 422. The security integration object 422 can include an identification of a role (e.g., one of the roles 420) associated with access to an external resource (e.g., storage resource 408 of the storage platform 105 or another resource).

At operation 1304, EAM 128 creates secret object 424, which can include a token. The token can be associated with the security integration object 422.

At operation 1306, EAM 128 binds the security integration object 422 and the secret object 424 to generate a storage integration object 402. The storage integration object can be an external access integration.

At operation 1308, EAM 128 retrieves a cloud provider token during the execution of a user-defined function (UDF).

At operation 1310, EAM 128 grants the UDF access to the external resource based on authenticating the cloud provider token using the external access integration.

FIG. 14 illustrates a diagrammatic representation of a machine 1400 in the form of a computer system within which a set of instructions may be executed to cause the machine 1400 to perform any one or more of the methodologies discussed herein, according to an example embodiment. Specifically, FIG. 14 shows a diagrammatic representation of machine 1400 in the example form of a computer system, within which instructions 1416 (e.g., software, a program, an application, an applet, an app, or other executable code) for causing the machine 1400 to perform any one or more of the methodologies discussed herein may be executed. For example, instructions 1416 may cause machine 1400 to execute any one or more operations of method 1300 (or any other technique discussed herein, for example, in connection with FIG. 1-FIG. 13). As another example, instructions 1416 may cause machine 1400 to implement one or more portions of the functionalities discussed herein. In this way, instructions 1416 may transform a general, non-programmed machine into a particular machine 1400 (e.g., the compute service manager 108 or a node in the execution platform 110) that is specially configured to carry out any one of the described and illustrated functions in the manner described herein. In yet another embodiment, instructions 1416 may configure the compute service manager 108 and/or a node in the execution platform 110 to carry out any one of the described and illustrated functions in the manner described herein.

In alternative embodiments, the machine 1400 operates as a standalone device or may be coupled (e.g., networked) to other machines. In a networked deployment, machine 1400 may operate in the capacity of a server machine or a client machine in a server-client network environment or as a peer machine in a peer-to-peer (or distributed) network environment. The machine 1400 may comprise, but not be limited to, a server computer, a client computer, a personal computer (PC), a tablet computer, a laptop computer, a netbook, a smartphone, a mobile device, a network router, a network switch, a network bridge, or any machine capable of executing the instructions 1416, sequentially or otherwise, that specify actions to be taken by the machine 1400. Further, while only a single machine 1400 is illustrated, the term “machine” shall also be taken to include a collection of machines 1400 that individually or jointly execute the instructions 1416 to perform any one or more of the methodologies discussed herein.

Machine 1400 includes processors 1410, memory 1430, and input/output (I/O) components 1450 configured to communicate with each other, such as via bus 1402. In some example embodiments, the processors 1410 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1412 and a processor 1414 that may execute the instructions 1416. The term “processor” is intended to include multi-core processors 1410 that may comprise two or more independent processors (sometimes referred to as “cores”) that may execute instructions 1416 contemporaneously. Although FIG. 14 shows multiple processors 1410, machine 1400 may include a single processor with a single core, a single processor with multiple cores (e.g., a multi-core processor), multiple processors with a single core, multiple processors with multiple cores, or any combination thereof.

The memory 1430 may include a main memory 1432, a static memory 1434, and a storage unit 1436, all accessible to the processors 1410, such as via the bus 1402. The main memory 1432, the static memory 1434, and the storage unit 1436 store the instructions 1416 embodying any one or more of the methodologies or functions described herein. The instructions 1416 may also reside, completely or partially, within the main memory 1432, within the static memory 1434, within machine storage medium 1438 of the storage unit 1436, within at least one of the processors 1410 (e.g., within the processor's cache memory), or any suitable combination thereof, during execution thereof by the machine 1400.

The I/O components 1450 include components to receive input, provide output, produce output, transmit information, exchange information, capture measurements, and so on. The specific I/O components 1450 that are included in a particular machine 1400 will depend on the type of machine. For example, portable machines such as mobile phones will likely include a touch input device or other such input mechanisms, while a headless server machine will likely not include such a touch input device. It will be appreciated that the I/O components 1450 may include many other components that are not shown in FIG. 14. The I/O components 1450 are grouped according to functionality merely to simplify the following discussion, and the grouping is in no way limiting. In various example embodiments, the I/O components 1450 may include output components 1452 and input components 1454. The output components 1452 may include visual components (e.g., a display such as a plasma display panel (PDP), a light-emitting diode (LED) display, a liquid crystal display (LCD), a projector, or a cathode ray tube (CRT)), acoustic components (e.g., speakers), other signal generators, and so forth. The input components 1454 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures or other tactile input components), audio input components (e.g., a microphone), and the like.

Communication may be implemented using a wide variety of technologies. The I/O components 1450 may include communication components 1464 operable to couple the machine 1400 to a network 1480 or devices 1470 via a coupling 1482 and a coupling 1472, respectively. For example, the communication components 1464 may include a network interface component or another suitable device to interface with the network 1480. In further examples, communication components 1464 may include wired communication components, wireless communication components, cellular communication components, and other communication components to provide communication via other modalities. The device 1470 may be another machine or any of a wide variety of peripheral devices (e.g., a peripheral device coupled via a universal serial bus (USB)). For example, as noted above, machine 1400 may correspond to any one of the compute service manager 108 or the execution platform 110, and device 1470 may include the client device 114 or any other computing device described herein as being in communication with the network-based database system 102 or the storage platform 105.

The various memories (e.g., 1430, 1432, 1434, and/or memory of the processor(s) 1410 and/or the storage unit 1436) may store one or more sets of instructions 1416 and data structures (e.g., software) embodying or utilized by any one or more of the methodologies or functions described herein. These instructions 1416, when executed by the processor(s) 1410, cause various operations to implement the disclosed embodiments.

As used herein, the terms “machine-storage medium,” “device-storage medium,” and “computer-storage medium” mean the same thing and may be used interchangeably in this disclosure. The terms refer to single or multiple storage devices and/or media (e.g., a centralized or distributed database and/or associated caches and servers) that store executable instructions and/or data. The terms shall accordingly be taken to include, but not be limited to, solid-state memories and optical and magnetic media, including memory internal or external to processors. Specific examples of machine-storage media, computer-storage media, and/or device-storage media include non-volatile memory, including by way of example, semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1480 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, network 1480 or a portion of network 1480 may include a wireless or cellular network, and coupling 1482 may be a Code Division Multiple Access (CDMA) connection, a Global System for Mobile Communications (GSM) connection, or another cellular or wireless coupling. In this example, the coupling 1482 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1416 may be transmitted or received over network 1480 using a transmission medium via a network interface device (e.g., a network interface component included in the communication components 1464) and utilizing any one of several well-known transfer protocols (e.g., hypertext transfer protocol (HTTP)). Similarly, instructions 1416 may be transmitted or received using a transmission medium via coupling 1472 (e.g., a peer-to-peer coupling) to device 1470. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1416 for execution by the machine 1400 and include digital or analog communications signals or other intangible media to facilitate communication of such software. Hence, the terms “transmission medium” and “signal medium” shall be taken to include any form of a modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the disclosed methods may be performed by one or more processors. The performance of certain operations may be distributed among the one or more processors, not only residing within a single machine but also deployed across several machines. In some example embodiments, the processor or processors may be located in a single location (e.g., within a home environment, an office environment, or a server farm), while in other embodiments, the processors may be distributed across several locations.

Described implementations of the subject matter can include one or more features, alone or in combination, as illustrated below by way of examples.

Example 1 is a system comprising at least one hardware processor and at least one memory storing instructions that cause the at least one hardware processor to perform operations comprising creating a security integration object, the security integration object comprising an identification of a role associated with access to an external resource; creating a secret object comprising a token, the token associated with the security integration object; binding the security integration object and the secret object to generate a storage integration object, the storage integration object comprising an external access integration; retrieving a cloud provider token during execution of a user-defined function (UDF); and granting the UDF, access to the external resource based on authenticating the cloud provider token using the external access integration.

In Example 2, the subject matter of Example 1 includes the operations comprising generating a network access rule, the network access rule comprising identification information of the external resource.

In Example 3, the subject matter of Example 2 includes the operations comprising generating the storage integration object further based on binding the network access rule with the security integration object and the secret object.

In Example 4, the subject matter of Examples 1-3 includes the operations comprising executing an application programming interface (API) to retrieve the cloud provider token, the API executing within a sandbox associated with the execution of the UDF.

In Example 5, the subject matter of Example 4 includes the operations comprising retrieving the storage integration object based on the cloud provider token and granting the UDF access to the external storage based on the retrieved storage integration object.

In Example 6, the subject matter of Examples 1-5 includes the operations comprising detecting the role is associated with an identity-based policy attached to a user and granting the user access to the external resource based on the authenticating.

In Example 7, the subject matter of Examples 1-6 includes the operations comprising detecting the role is associated with a resource-based policy attached to a storage resource associated with the external resource and granting the UDF access to the storage resource based on the authenticating.

In Example 8, the subject matter of Examples 1-7 includes the following operations: updating an egress policy based on the storage integration object.

In Example 9, the subject matter of Example 8 includes the operations comprising forwarding the egress policy to an execution node, the execution node hosting a sandbox process associated with the execution of the UDF, and granting the UDF access to the external resource based on authenticating the cloud provider token at the execution node based on the egress policy.

In Example 10, the subject matter of Examples 1-9 includes wherein granting the UDF access to the external resource comprises causing authorization of a user object of a network-based database system to access the role and granting the user object, access to the external resource based on the authenticating of the cloud provider token using the storage integration object.

Example 11 is a method comprising: creating, by at least one hardware processor, a security integration object, the security integration object comprising an identification of a role associated with access to external storage; creating a secret object comprising a token, the token associated with the security integration object; binding the security integration object and the secret object to generate a storage integration object, the storage integration object comprising an external access integration; retrieving a cloud provider token during execution of a user-defined function (UDF); and granting the UDF, access to the external resource based on authenticating the cloud provider token using the external access integration.

In Example 12, the subject matter of Example 11 includes generating a network access rule, the network access rule comprising identification information of the external resource.

In Example 13, the subject matter of Example 12 includes generating the storage integration object further based on binding the network access rule with the security integration object and the secret object.

In Example 14, the subject matter of Examples 11-13 includes executing an application programming interface (API) to retrieve the cloud provider token, the API executing within a sandbox associated with the execution of the UDF.

In Example 15, the subject matter of Example 14 includes retrieving the storage integration object based on the cloud provider token and granting the UDF access to the external resource based on the retrieved storage integration object.

In Example 16, the subject matter of Examples 11-15 includes detecting the role is associated with an identity-based policy attached to a user and granting the user access to the external resource based on the authenticating.

In Example 17, the subject matter of Examples 11-16 includes detecting the role is associated with a resource-based policy attached to a storage resource associated with the external resource and granting the UDF access to the storage resource based on the authenticating.

In Example 18, the subject matter of Examples 11-17 includes updating an egress policy based on the storage integration object.

In Example 19, the subject matter of Example 18 includes forwarding the egress policy to an execution node, the execution node hosting a sandbox process associated with the execution of the UDF and granting the UDF access to the external resource based on authenticating the cloud provider token at the execution node based on the egress policy.

In Example 20, the subject matter of Examples 11-19 includes wherein granting the UDF access to the external resource comprises causing authorization of a user object of a network-based database system to access the role and granting the user object access to the external resource based on the authenticating of the cloud provider token using the storage integration object.

Example 21 is a computer-storage medium comprising instructions that, when executed by one or more processors of a machine, configure the machine to perform operations comprising creating a security integration object, the security integration object comprising an identification of a role associated with access to external storage; creating a secret object comprising a token, the token associated with the security integration object; binding the security integration object and the secret object to generate a storage integration object, the storage integration object comprising an external access integration; retrieving a cloud provider token during execution of a user-defined function (UDF); and granting the UDF, access to the external resource based on authenticating the cloud provider token using the external access integration.

In Example 22, the subject matter of Example 21 includes the operations comprising generating a network access rule, the network access rule comprising identification information of the external resource.

In Example 23, the subject matter of Example 22 includes the operations comprising generating the storage integration object further based on binding the network access rule with the security integration object and the secret object.

In Example 24, the subject matter of Examples 21-23 includes the operations comprising executing an application programming interface (API) to retrieve the cloud provider token, the API executing within a sandbox associated with the execution of the UDF.

In Example 25, the subject matter of Example 24 includes the operations comprising retrieving the storage integration object based on the cloud provider token and granting the UDF access to the external resource based on the retrieved storage integration object.

In Example 26, the subject matter of Examples 21-25 includes the operations comprising detecting the role is associated with an identity-based policy attached to a user and granting the user access to the external resource based on the authenticating.

In Example 27, the subject matter of Examples 21-26 includes the operations comprising detecting the role is associated with a resource-based policy attached to a storage resource associated with the external resource and granting the UDF access to the storage resource based on the authenticating.

In Example 28, the subject matter of Examples 21-27 includes the operations comprising updating an egress policy based on the storage integration object.

In Example 29, the subject matter of Example 28 includes the operations comprising forwarding the egress policy to an execution node, the execution node hosting a sandbox process associated with the execution of the UDF, and granting the UDF access to the external resource based on authenticating the cloud provider token at the execution node based on the egress policy.

In Example 30, the subject matter of Examples 21-29 includes wherein the operations for granting the UDF access to the external resource comprise causing authorization of a user object of a network-based database system to access the role and granting the user object access to the external resource based on the authenticating of the cloud provider token using the storage integration object.

Example 31 is at least one machine-readable medium, including instructions that, when executed by processing circuitry, cause the processing circuitry to perform operations to implement any of Examples 1-30.

Example 32 is an apparatus comprising means to implement any of Examples 1-30.

Example 33 is a system to implement any of Examples 1-30.

Example 34 is a method to implement any of Examples 1-30.

Although the embodiments of the present disclosure have been described concerning specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various embodiments. Combinations of the above embodiments and other embodiments not specifically described herein will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory storing instructions that cause the at least one hardware processor to perform operations comprising:
creating a security integration object, the security integration object comprising an identification of a role associated with access to an external resource;
creating a secret object comprising a token, the token associated with the security integration object;
binding the security integration object and the secret object to generate a storage integration object, the storage integration object comprising an external access integration;
retrieving a cloud provider token during execution of a user-defined function (UDF); and
granting the UDF access to the external resource based on authenticating the cloud provider token using the external access integration.

2. The system of claim 1, the operations comprising:
generating a network access rule, the network access rule comprising identification information of the external resource.

3. The system of claim 2, the operations comprising:
generating the storage integration object further based on binding the network access rule with the security integration object and the secret object.

4. The system of claim 1, the operations comprising:
executing an application programming interface (API) to retrieve the cloud provider token, the API executing within a sandbox associated with the execution of the UDF.

5. The system of claim 4, the operations comprising:
retrieving the storage integration object based on the cloud provider token; and
granting the UDF access to the external storage based on the retrieved storage integration object.

6. The system of claim 1, the operations comprising:
detecting the role is associated with an identity-based policy attached to a user; and
granting the user, access to the external resource based on the authenticating.

7. The system of claim 1, the operations comprising:
detecting the role is associated with a resource-based policy attached to a storage resource associated with the external resource; and
granting the UDF access to the storage resource based on the authenticating.

8. The system of claim 1, the operations comprising:
updating an egress policy based on the storage integration object.

9. The system of claim 8, the operations comprising:
forwarding the egress policy to an execution node, the execution node hosting a sandbox process associated with the execution of the UDF; and
granting the UDF access to the external resource based on authenticating the cloud provider token at the execution node based on the egress policy.

10. The system of claim 1, wherein granting the UDF access to the external resource comprises:
causing authorization of a user object of a network-based database system to access the role; and
granting the user object access to the external resource based on the authenticating of the cloud provider token using the storage integration object.

11. A method comprising:
creating, by at least one hardware processor, a security integration object, the security integration object comprising an identification of a role associated with access to external storage;
creating a secret object comprising a token, the token associated with the security integration object;
binding the security integration object and the secret object to generate a storage integration object, the storage integration object comprising an external access integration;
retrieving a cloud provider token during execution of a user-defined function (UDF); and
granting the UDF access to the external resource based on authenticating the cloud provider token using the external access integration.

12. The method of claim 11, comprising:
generating a network access rule, the network access rule comprising identification information of the external resource.

13. The method of claim 12, comprising:
generating the storage integration object further based on binding the network access rule with the security integration object and the secret object.

14. The method of claim 11, comprising:
executing an application programming interface (API) to retrieve the cloud provider token, the API executing within a sandbox associated with the execution of the UDF.

15. The method of claim 14, comprising:
retrieving the storage integration object based on the cloud provider token; and
granting the UDF access to the external resource based on the retrieved storage integration object.

16. The method of claim 11, comprising:
detecting the role is associated with an identity-based policy attached to a user; and
granting the user, access to the external resource based on the authenticating.

17. The method of claim 11, comprising:
detecting the role is associated with a resource-based policy attached to a storage resource associated with the external resource; and
granting the UDF access to the storage resource based on the authenticating.

18. The method of claim 11, comprising:
updating an egress policy based on the storage integration object.

19. The method of claim 18, comprising:
forwarding the egress policy to an execution node, the execution node hosting a sandbox process associated with the execution of the UDF; and
granting the UDF access to the external resource based on authenticating the cloud provider token at the execution node based on the egress policy.

20. The method of claim 11, wherein granting the UDF access to the external resource comprises:
causing authorization of a user object of a network-based database system to access the role; and
granting the user object access to the external resource based on the authenticating of the cloud provider token using the storage integration object.

21. A computer-storage medium comprising instructions that, when executed by one or more processors of a machine, configure the machine to perform operations comprising:
creating a security integration object, the security integration object comprising an identification of a role associated with access to external storage;
creating a secret object comprising a token, the token associated with the security integration object;
binding the security integration object and the secret object to generate a storage integration object, the storage integration object comprising an external access integration;
retrieving a cloud provider token during execution of a user-defined function (UDF); and
granting the UDF access to the external resource based on authenticating the cloud provider token using the external access integration.

22. The computer-storage medium of claim 21, the operations comprising:
generating a network access rule, the network access rule comprising identification information of the external resource.

23. The computer-storage medium of claim 22, the operations comprising:
generating the storage integration object further based on binding the network access rule with the security integration object and the secret object.

24. The computer-storage medium of claim 21, the operations comprising:
executing an application programming interface (API) to retrieve the cloud provider token, the API executing within a sandbox associated with the execution of the UDF.

25. The computer-storage medium of claim 24, the operations comprising:
retrieving the storage integration object based on the cloud provider token; and
granting the UDF access to the external resource based on the retrieved storage integration object.

26. The computer-storage medium of claim 21, the operations comprising:
detecting the role is associated with an identity-based policy attached to a user; and
granting the user, access to the external resource based on the authenticating.

27. The computer-storage medium of claim 21, the operations comprising:
detecting the role is associated with a resource-based policy attached to a storage resource associated with the external resource; and
granting the UDF access to the storage resource based on the authenticating.

28. The computer-storage medium of claim 21, the operations comprising:
updating an egress policy based on the storage integration object.

29. The computer-storage medium of claim 28, the operations comprising:
forwarding the egress policy to an execution node, the execution node hosting a sandbox process associated with the execution of the UDF; and
granting the UDF access to the external resource based on authenticating the cloud provider token at the execution node based on the egress policy.

30. The computer-storage medium of claim 21, wherein the operations for granting the UDF access to the external resource comprise:
causing authorization of a user object of a network-based database system to access the role; and
granting the user object access to the external resource based on the authenticating of the cloud provider token using the storage integration object.
